(19) United States
(12) Patent Application Publication
(10) Pub. No.: US 2025/0081087 A1
(43) Pub. Date: Mar. 6, 2025

(54) PRIORITIZATION OF BOOMING CELLS IN WIRELESS NETWORK

(71) Applicant: Rakuten Symphony, Inc., Tokyo (JP)

(72) Inventors: Durgesh RATHORE, Indore (IN); Atul RAJPOOT, Indore (IN); Sudeep Kumar JAIN, Indore (IN); Nilesh BANKAR, Indore (IN)

(73) Assignee: Rakuten Symphony, Inc., Tokyo (JP)

(21) Appl. No.: 18/021,016

(22) PCT Filed: Dec. 28, 2022
(86) PCT No.: PCT/US2022/054111

§ 371 Date: Feb. 13, 2023

(30) Foreign Application Priority Data
Nov. 15, 2022 (IN) 202221065313

(51) Int. Cl. H04W 48/16; H04W 24/02; H04W 72/566

(52) U.S. Cl. CPC H04W 48/16; H04W 24/02; H04W 72/566

(57) ABSTRACT

Embodiments herein provide a method for prioritizing booming cells in a wireless network by an electronic device. The method includes receiving information about a plurality of booming cells. Further, the method includes determining a priority for each booming cell of the plurality of booming cells based on a morphology factor, a PRB utilization factor, a RRC connected users factor, a booming distance, and a user density factor. Further, the method includes prioritizing the plurality of booming cells for mitigation based on the priority for each booming cell of the plurality of booming cells.

### FIELD OF INVENTION

The present disclosure relates to a wireless network, and more particularly to a method and an electronic device for prioritizing booming cells in the wireless network.

### BACKGROUND

In general, a network service provider desires to provide optimal cellular coverage for users for providing a network service (e.g., voice call, video call, messaging service or the like). Booming cells are cells which provides coverage beyond its coverage limit in a wireless network. Basically, the booming cells can be considered as bad booming cells, so that network service provider try to avoid or omit the bad booming cells in a wireless network. Hence, there is a need to a method and an electronic device to prioritize the bad booming cells (e.g., network coverage loopholes or network gaps) so that a user (e.g., radio frequency (RF) engineer or operator) gets to know the exact severity of the bad booming cells to optimize the booming cells for providing better service to a customer, but existing methods and systems do not have any prior techniques or methods to prioritize the booming cells. Thus, results in reducing/degrading a user service experience.

Thus, it is desired to address the above-mentioned disadvantages or other shortcomings or at least provide a useful alternative.

### OBJECT OF INVENTION

The principal object of the embodiments herein is to provide a method and an electronic device for prioritizing booming cells in a wireless network. The proposed method can be used to prioritize the booming cells (e.g., network coverage loopholes or network gaps) so that a user (e.g., radio frequency (RF) engineer, operator or the like) of the electronic device gets to know the exact severity of the booming cells to optimize the booming cells for providing better service to the customer. The method can be used to assist the user to decide which booming cells should be mitigate first based on the identified priority in order to improve the network performance in an important geographical area. The method can be used to avoid coverage gaps or service gaps in the wireless network.

### SUMMARY

Accordingly, the embodiment herein discloses an electronic device for prioritizing booming cells in a wireless network. The electronic device includes a processor communicatively coupled to a memory. The processor receives information about a plurality of booming cells. Further, the processor determines a morphology factor of each booming cell of the plurality of booming cells and a Physical Resource Block (PRB) utilization factor of each booming cell of the plurality of booming cells. Further, the processor determines a number of Radio Resource Control (RRC) connected users factor of each booming cell of the plurality of booming cells. Further, the processor determines a booming distance of each booming cell of the plurality of booming cells. Further, the processor determines a user density factor of each booming cell of the plurality of booming cells. Further, the processor determines a priority for each booming cell of the plurality of booming cells based on the morphology factor, the PRB utilization, the RRC connected users, the booming distance, and the user density factor. Further, the processor prioritizes the plurality of booming cells for mitigation based on the priority for each booming cell of the plurality of booming cells.

Accordingly, the embodiment herein discloses a method for prioritizing booming cells in a wireless network. The method includes receiving, by an electronic device in the wireless network, information about a plurality of booming cells. Further, the method includes determining, by the electronic device, a morphology factor of each booming cell of the plurality of booming cells. Further, the method includes determining, by the electronic device, a PRB utilization factor of each booming cell of the plurality of booming cells. Further, the method includes determining, by the electronic device, a number of RRC connected users factor of each booming cell of the plurality of booming cells. Further, the method includes determining, by the electronic device, a booming distance of each booming cell of the plurality of booming cells. Further, the method includes determining, by the electronic device, a user density factor of each booming cell of the plurality of booming cells. Further, the method includes determining, by the electronic device, a priority for each booming cell of the plurality of booming cells based on the morphology factor, the PRB utilization factor, the RRC connected users factor, the booming distance, and the user density factor. Further, the method includes prioritizing, by the electronic device, the plurality of booming cells for mitigation based on the priority for each booming cell of the plurality of booming cells.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

### BRIEF DESCRIPTION OF FIGURES

The method and the electronic device are illustrated in the accompanying drawings, throughout which like reference letters indicate corresponding parts in the various figures. The embodiments herein will be better understood from the following description with reference to the drawings, in which:

FIG. 1 is an example overview of a wireless network for prioritizing booming cells, according to the embodiments as disclosed herein;

FIG. 2 shows various hardware components of an electronic device for prioritizing the booming cells in the wireless network, according to the embodiments as disclosed herein;

FIG. 3A to FIG. 3C are flow charts illustrating a method for prioritizing the booming cells in the wireless network, according to the embodiments as disclosed herein;

FIG. 4A to FIG. 4D are example flow charts illustrating a method for prioritizing the booming cells in the wireless network, according to the embodiments as disclosed herein;

FIG. 5 is an example illustration in which a user interface of the electronic device displays bandwidth related information and a geography related information to prioritize the booming cells in the wireless network, according to the embodiments as disclosed herein;

FIG. 6 is an example illustration in which a user interface of the electronic device displays bandwidth related information and layer setting to prioritize the booming cells in the wireless network, according to the embodiments as disclosed herein; and

FIG. 7 is an example illustration in which a user interface of the electronic device prioritizes the booming cells, according to the embodiments as disclosed herein.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Accordingly, the embodiment herein is to provide a method for prioritizing booming cells in a wireless network. The method includes receiving, by an electronic device in the wireless network, information about a plurality of booming cells. Further, the method includes determining, by the electronic device, a morphology factor of each booming cell of the plurality of booming cells. Further, the method includes determining, by the electronic device, a PRB utilization factor of each booming cell of the plurality of booming cells. Further, the method includes determining, by the electronic device, a number of RRC connected users factor of each booming cell of the plurality of booming cells. Further, the method includes determining, by the electronic device, a booming distance of each booming cell of the plurality of booming cells. Further, the method includes determining, by the electronic device, a user density factor of each booming cell of the plurality of booming cells. Further, the method includes determining, by the electronic device, a priority for each booming cell of the plurality of booming cells based on the morphology factor, the PRB utilization factor, the RRC connected users factor, the booming distance, and the user density factor. Further, the method includes prioritizing, by the electronic device, the plurality of booming cells for mitigation based on the priority for each booming cell of the plurality of booming cells.

Unlike conventional methods and systems, the proposed method can be used to prioritize the booming cells (e.g., network coverage loopholes or network gaps) so that a user (e.g., radio frequency (RF) engineer, operator or the like) of the electronic device gets to know the exact severity of the booming cells to optimize the booming cells for providing better service to the customer. The method can be used to assist the user to decide which booming cells should be mitigate first based on the identified priority in order to improve the network performance in an important geographical area. The method can be used to avoid coverage gaps or service gaps in the wireless network.

The method can be implemented on a respective band & L4 geography (in other words, the method is implemented on a respective band and postal code).

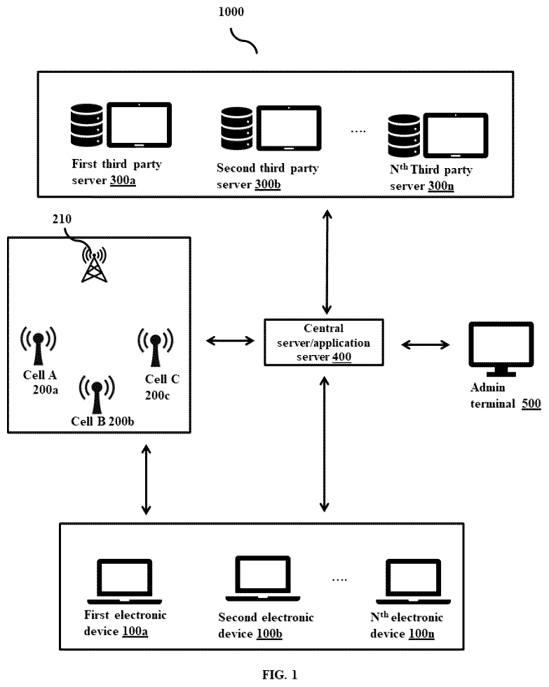

Referring now to the drawings and more particularly to FIGS. 1 through 7, where similar reference characters denote corresponding features consistently throughout the figures, there are shown preferred embodiments.

FIG. 1 is an example overview of a wireless network (1000) for prioritizing booming cells, according to the embodiments as disclosed herein. The wireless network (1000) can be, for example, but not limited to, a fourth generation (4G) network, a fifth generation (5G) network, a sixth generation (6G) network, an open radio access network (ORAN) network or the like. In an embodiment, the wireless network (1000) includes a plurality of electronic device (100a-100n), a plurality of cells (200a-200c), a base station (210), a plurality of third party servers (300a-300c), a central server/application server (400), and an admin terminal (500) (e.g., computer, laptop or the like). The central server/application server (400), the admin terminal (500) and the plurality of third party servers (600a-600c) monitor and store information about the booming cell.

In the wireless network (1000), the base station (or network elements) (210) are providing a service in the cells (200a-200c), respectively. The base station (210) provides the service to the electronic devices (100a-100c) in the cell (200a), similarly, the base station (210) provides the service to another electronic devices (not shown) in the cell (200b). The service can be, for example, but not limited to a call service, a voice communication service, a messaging service, a video streaming service, Internet of Things (IoT) services or the like. Hereafter, the label of the electronic device is 100 and the cell is 200.

The booming cells are cells which provides coverage beyond its coverage limit. Basically the booming cells can be considered as bad booming cells.

The electronic device (100) can be, for example, but not limited to a computer system, a host server, a personal computer, a smart phone, a Personal Digital Assistant (PDA), a tablet computer, a laptop computer, an Internet of Things (IoT), embedded systems, edge devices, a vehicle to everything (V2X) device or the like.

The electronic device (100) receives information about a plurality of booming cells (200a-200c). The information can be, for example, but not limited to radio frequency (RF) planning, changing design dynamics, cell capacity, cell edge changes overtime, performance optimization, physical obstruction information, antenna azimuth or the like.

Further, the electronic device (100) determines a morphology factor of each booming cell of the plurality of booming cells (200a-200c). In an embodiment, the electronic device (100) retrieves a weightage for the morphology factor for each booming cell of the plurality of booming cells (200a-200c) from a morphology database (not shown). Further, the electronic device (100) determines the morphology factor based on the weightage for the morphology factor and a morphology multiplier factor. In an example, the electronic device (100) determines the morphology factor of each booming cell of the plurality of booming cells (200a-200c) using table 1.

TABLE 1

| Morphology factor | Value |
|---|---|
| Urban | 2 |
| Rural | 1 |
| Suburban | 1 |
| Other | 0 |

Further, the electronic device (100) determines a PRB utilization factor of each booming cell of the plurality of booming cells (200a-200c). In an embodiment, the electronic device (100) determines an average PRB utilization on weekly basis and a maximum average PRB utilization on weekly basis. In an embodiment, the average PRB utilization and the maximum average PRB utilization are determined based on various time interval. The time interval could be per day basic, per week basic, or per month basic. In an example, the electronic device (100) determines the PRB utilization of each booming cell of the plurality of booming cells (200a-200c) using below equation (1).

$$PRB Utilization = ( AVG DL PRB Utilization Hourly / Max . ( AVG DL PRB Utilization Hourly ) \qquad ( 1 )$$

Based on the average PRB utilization on the weekly basis and the maximum average PRB utilization on the weekly basis, the electronic device (100) determines a PRB utilization weightage of each booming cell of booming cells (200a-200c). Further, the electronic device (100) determines the PRB utilization factor based on the PRB utilization weightage and a PRB utilization multiplier factor. In an example, the PRB utilization multiplier factor is 1. In another example, the PRB utilization multiplier factor is set by the RF engineer of the electronic device (100). In another example, the booming multiplier factor is set by the electronic device (100).

Further, the electronic device (100) determines a number of RRC connected users factor of each booming cell of the plurality of booming cells (200a-200c). In an embodiment, the electronic device (100) determines an average RRC connected users on weekly basis and a maximum RRC connected users on weekly basis. In an embodiment, the average RRC connected users and the maximum RRC connected users are determined based on various time interval. The time interval could be per day basic, per week basic, or per month basic. In an example, the electronic device (100) determines the number of RRC connected users factor of each booming cell of the plurality of booming cells (200a-200c) using equation (2).

$$RRC Factor = AVGRRC Connected User\_Hourly / Max ( AVGRRC Connected User\_Hourly ) under all postal code \qquad ( 2 )$$

Based on the average RRC connected users on the weekly basis and the maximum RRC connected users on the weekly basis, the electronic device (100) determines a number of RRC connected users weightage of each booming cell of booming cells (200a-200c). Further, the electronic device (100) determines the number of RRC connected users factor based on the number of RRC connected users weightage and a RRC connected user multiplier factor. In an example, the RRC connected user multiplier factor is 1. In another example, the RRC connected user multiplier factor is set by the RF engineer of the electronic device (100). In another example, the RRC connected user multiplier factor is set by the electronic device (100).

Further, the electronic device (100) determines a booming distance of each booming cell of the plurality of booming cells (200a-200c). In an embodiment, the electronic device (100) detects a booming cell start distance and a booming cell stop distance of each booming cell of the plurality of booming cells (200a-200c). Further, the electronic device (100) determines a total booming distance based on the booming cell start distance and the booming cell stop distance. Further, the electronic device (100) determines a booming distance weightage based on the total booming distance and a maximum booming distance. Further, the electronic device (100) determines the booming distance factor based on the booming distance weightage and a booming multiplier factor. In an example, the booming multiplier factor is 2. In another example, the booming multiplier factor is set by the RF engineer of the electronic device. In another example, the booming multiplier factor is set by the electronic device (100).

Further, the electronic device (100) determines a user density factor of each booming cell of the plurality of booming cells (200a-200c). In an embodiment, the electronic device (100) retrieves a plurality of samples of the booming cells (200a-200c). Further, the electronic device (100) determines a maximum sample of the plurality of samples of the booming cells (200a-200c). Based on the plurality of samples of the booming cells (200a-200c) and the maximum sample, the electronic device (100) determines a user density weightage. Further, the electronic device (100) determines the user density factor based on the user density weightage and a user density multiplier factor. In an example, the user density multiplier factor is 3. In another example, the user density multiplier factor is set by the RF engineer of the electronic device (100). In another example, the user density multiplier factor is set by the electronic device (100).

Based on the morphology factor, the PRB utilization, the RRC connected users, the booming distance, and the user density factor, the electronic device (100) determines a priority for each booming cell of the plurality of booming cells (200a-200c). Further, the electronic device (100) prioritizes the plurality of booming cells (200a-200c) for mitigation based on the priority for each booming cell of the plurality of booming cells (200a-200c). In an embodiment, the electronic device (100) sorts the priority of the plurality of booming cells (200a-200c) in a descending order or the ascending order. Further, the electronic device (100) ranks the plurality of booming cells (200a-200c) based on the sorted priority of the plurality of booming cells (200a-200c). In an example, first priority may be ranking better or equal to 75^{th} percentile, a second priority may be ranking in range of 74^{th} percentile to 50 percentile, and a third priority may be below 50 percentile.

The electronic device (100) prioritizes the booming cells (e.g., network coverage loopholes, service gaps or network gaps) so that a user (e.g., radio frequency (RF) engineer, operator or the like) of the electronic device (100) gets to know the exact severity of the booming cells (200a-200c) to optimize the booming cells (200a-200c) for providing better service to the customer. The electronic device (100) can be used to assist the user to decide which booming cells (200a-200c) should be mitigate first based on the identified priority in order to improve the network performance in an important geographical area. The electronic device (100) can be used to avoid coverage gaps or service gaps in the wireless network (1000).

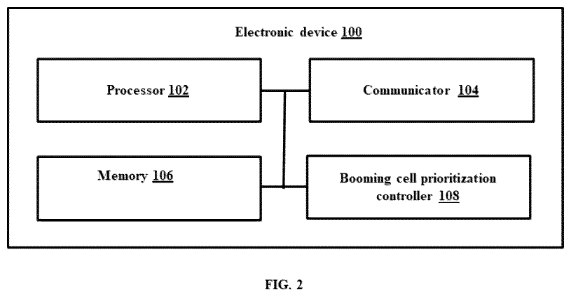

FIG. 2 shows various hardware components of an electronic device (100) for the booming cells (200a-200c) in the wireless network (1000), according to the embodiments as disclosed herein. In an embodiment, the electronic device (100) includes a processor (110), a communicator (120), a memory (130) and a booming cell prioritization controller (140). The processor (110) is coupled with the communicator (120), the memory (130) and the booming cell prioritization controller (140).

The booming cell prioritization controller (140) receives the information about the plurality of booming cells (200a-200c). Further, the booming cell prioritization controller (140) determines the morphology factor of each booming cell of the plurality of booming cells (200a-200c). In an embodiment, the booming cell prioritization controller (140) retrieves the weightage for the morphology factor for each booming cell of the plurality of booming cells (200a-200c) from the morphology database. Further, the booming cell prioritization controller (140) determines the morphology factor based on the weightage for the morphology factor and the morphology multiplier factor. In an example, the morphology multiplier factor for a distributed unit (DU) is 3, a centralized unit (CU) is 2, a radio unit (RU) is 1. In another example, the morphology multiplier factor is set by the RF engineer of the electronic device (100). In another example, the booming multiplier factor is set by the electronic device (100).

Further, the booming cell prioritization controller (140) determines the PRB utilization factor of each booming cell of the plurality of booming cells (200a-200c). In an embodiment, the booming cell prioritization controller (140) determines the average PRB utilization on weekly basis and the maximum average PRB utilization on weekly basis. Based on the average PRB utilization on the weekly basis and the maximum average PRB utilization on the weekly basis, the booming cell prioritization controller (140) determines the PRB utilization weightage of each booming cell of booming cells (200a-200c). Further, the booming cell prioritization controller (140) determines the PRB utilization factor based on the PRB utilization weightage and the PRB utilization multiplier factor.

Further, the booming cell prioritization controller (140) determines the number of RRC connected users factor of each booming cell of the plurality of booming cells (200a-200c). In an embodiment, the booming cell prioritization controller (140) determines the average RRC connected users on weekly basis and the maximum RRC connected users on weekly basis. Based on the average RRC connected users on the weekly basis and the maximum RRC connected users on the weekly basis, the booming cell prioritization controller (140) determines the number of RRC connected users weightage of each booming cell of booming cells (200a-200c). Further, the booming cell prioritization controller (140) determines the number of RRC connected users factor based on the number of RRC connected users weightage and the RRC connected user multiplier factor.

Further, the booming cell prioritization controller (140) determines the booming distance of each booming cell of the plurality of booming cells (200a-200c). In an embodiment, the booming cell prioritization controller (140) detects the booming cell start distance and the booming cell stop distance of each booming cell of the plurality of booming cells (200a-200c). Further, the booming cell prioritization controller (140) determines the total booming distance based on the booming cell start distance and the booming cell stop distance. Further, the booming cell prioritization controller (140) determines the booming distance weightage based on the total booming distance and the maximum booming distance. Further, the booming cell prioritization controller (140) determines the booming distance factor based on the booming distance weightage and the booming multiplier factor.

Further, the booming cell prioritization controller (140) determines the user density factor of each booming cell of the plurality of booming cells (200a-200c). In an embodiment, the booming cell prioritization controller (140) retrieves the plurality of samples of the booming cells (200a-200c). Further, the booming cell prioritization controller (140) determines the maximum sample of the plurality of samples of the booming cells (200a-200c). Based on the plurality of samples of the booming cells (200a-200c) and the maximum sample, the booming cell prioritization controller (140) determines the user density weightage. Further, the booming cell prioritization controller (140) determines the user density factor based on the user density weightage and the user density multiplier factor.

Based on the morphology factor, the PRB utilization, the RRC connected users, the booming distance, and the user density factor, the booming cell prioritization controller (140) determines the priority for each booming cell of the plurality of booming cells (200a-200c). Further, the booming cell prioritization controller (140) prioritizes the plurality of booming cells (200a-200c) for mitigation based on the priority for each booming cell of the plurality of booming cells (200a-200c). In an embodiment, the booming cell prioritization controller (140) sorts the priority of the plurality of booming cells (200a-200c) in the descending order or the ascending order. Further, the booming cell prioritization controller (140) ranks the plurality of booming cells based on the sorted priority of the plurality of booming cells (200a-200c).

The booming cell prioritization controller (140) prioritizes the booming cells (e.g., network coverage loopholes or network gaps) so that a user (e.g., radio frequency (RF) engineer, operator or the like) of the electronic device (100) gets to know the exact severity of the booming cells (200a-200c) to optimize the booming cells (200a-200c) for providing better service to the customer. The booming cell prioritization controller (140) can be used to assist the user to decide which booming cells (200a-200c) should be mitigate first based on the identified priority in order to improve the network performance in an important geographical area. The booming cell prioritization controller (140) can be used to avoid coverage gaps or service gaps in the wireless network (1000).

The booming cell prioritization controller (140) is implemented by analog and/or digital circuits such as logic gates, integrated circuits, the processor (110), microprocessors, microcontrollers, memory circuits, passive electronic components, active electronic components, optical components, hardwired circuits and the like, and may optionally be driven by firmware.

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 2 shows various hardware components of the electronic device (100) but it is to be understood that other embodiments are not limited thereon. In other embodiments, the electronic device (100) may include less or more number of components. Further, the labels or names of the components are used only for illustrative purpose and does not limit the scope of the invention. One or more components can be combined together to perform same or substantially similar function in the electronic device (100).

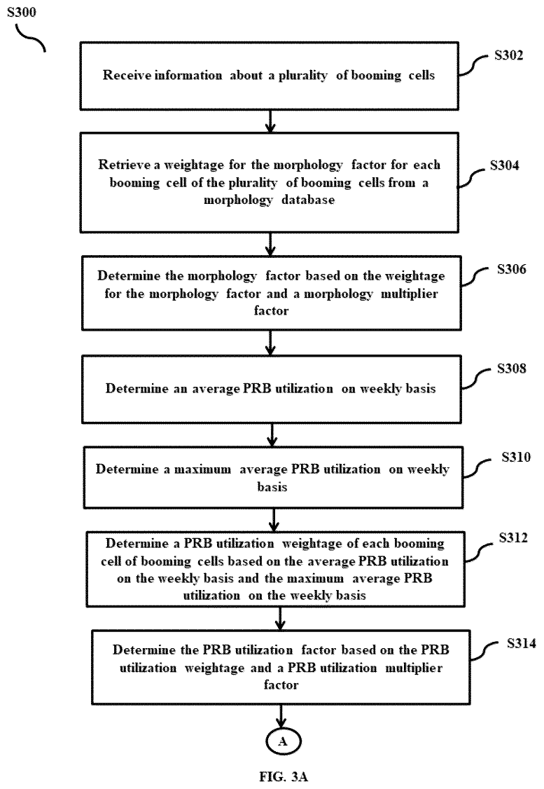

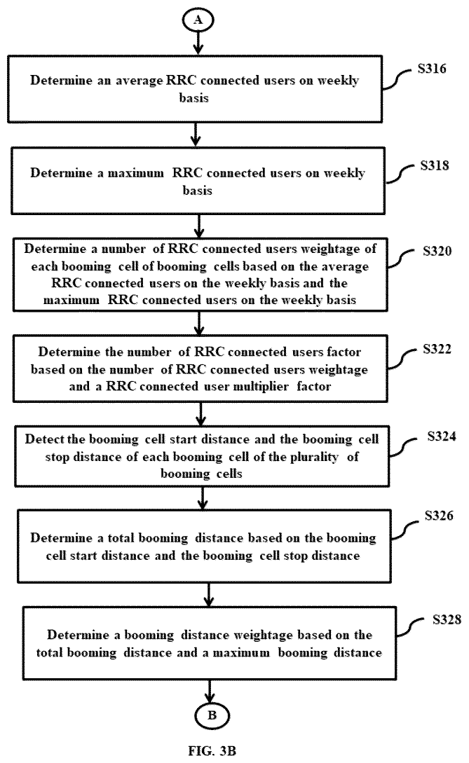

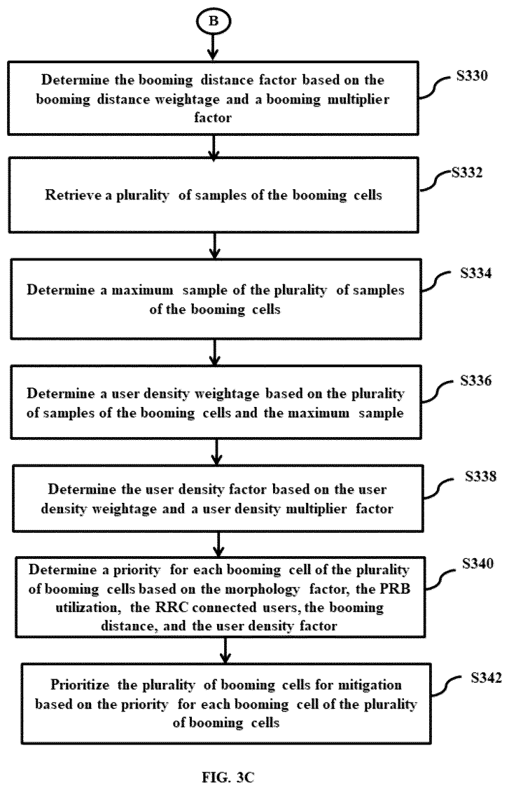

FIG. 3A to FIG. 3C are flow charts (S300) illustrating a method for prioritizing the booming cells (200a-200c) in the wireless network (1000), according to the embodiments as disclosed herein. The operations (S302-S342) are handled by the booming cell prioritization controller (140).

At S302, the method includes receiving the information about the plurality of booming cells (200a-200c). At S304, the method includes retrieving the weightage for the morphology factor for each booming cell of the plurality of booming cells (200a-200c) from the morphology database. At S306, the method includes determining the morphology factor based on the weightage for the morphology factor and the morphology multiplier factor. At S308, the method includes determining the average PRB utilization on the weekly basis. At S310, the method includes determining the maximum average PRB utilization on weekly basis. At S312, the method includes determining the PRB utilization weightage of each booming cell of booming cells (200a-200c) based on the average PRB utilization on the weekly basis and the maximum average PRB utilization on the weekly basis. At S314, the method includes determining the PRB utilization factor based on the PRB utilization weightage and the PRB utilization multiplier factor.

At S316, the method includes determining the average RRC connected users on weekly basis. At S318, the method includes determining the maximum RRC connected users on the weekly basis. At S320, the method includes determining the number of RRC connected users weightage of each booming cell of booming cells (200a-200c) based on the average RRC connected users on the weekly basis and the maximum RRC connected users on the weekly basis. At S322, the method includes determining the number of RRC connected users factor based on the number of RRC connected users weightage and the RRC connected user multiplier factor.

At S324, the method includes detecting the booming cell start distance and the booming cell stop distance of each booming cell of the plurality of booming cells (200a-200c). At S326, the method includes determining the total booming distance based on the booming cell start distance and the booming cell stop distance. At S328, the method includes determining the booming distance weightage based on the total booming distance and the maximum booming distance. At S330, the method includes determining the booming distance factor based on the booming distance weightage and the booming multiplier factor.

At S332, the method includes retrieving the plurality of samples of the booming cells (200a-200c). At S334, the method includes determining the maximum sample of the plurality of samples of the booming cells (200a-200c). At S336, the method includes determining the user density weightage based on the plurality of samples of the booming cells (200a-200c) and the maximum sample. At S338, the method includes determining the user density factor based on the user density weightage and the user density multiplier factor. At S340, the method includes determining the priority for each booming cell of the plurality of booming cells (200a-200c) based on the morphology factor, the PRB utilization, the RRC connected users, the booming distance, and the user density factor. At S342, the method includes prioritizing the plurality of booming cells (200a-200c) for mitigation based on the priority for each booming cell of the plurality of booming cells (200a-200c).

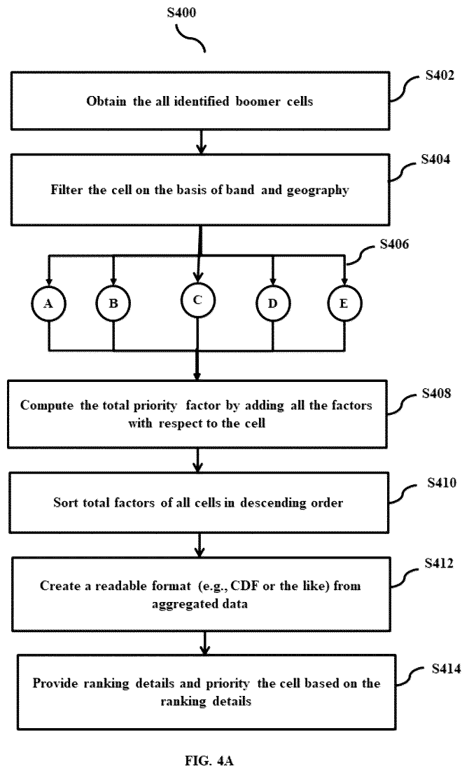

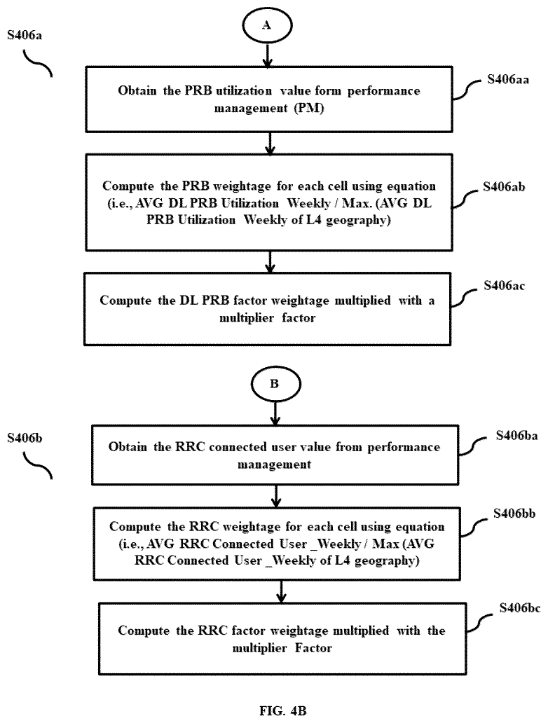

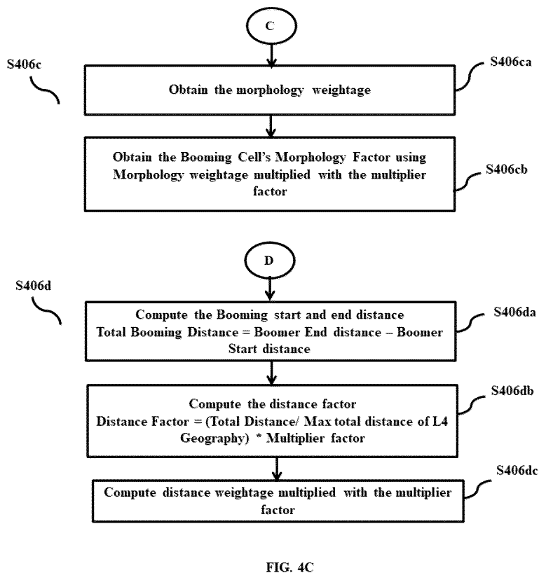

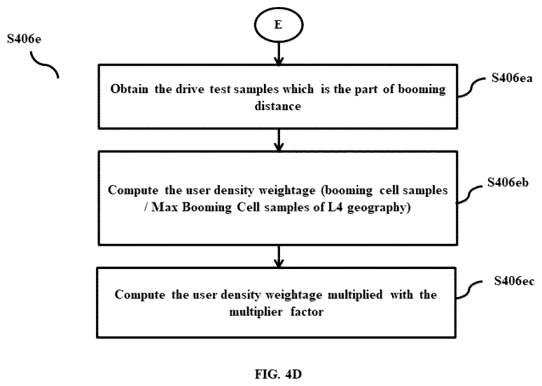

FIG. 4A to FIG. 4D are example flow charts (S400) illustrating a method for prioritizing the booming cells (200a-200c) in the wireless network (1000), according to the embodiments as disclosed herein. The operations (S402-S414) are handled by the booming cell prioritization controller (140).

At S402, the method includes obtaining the information of the all identified boomer cells (200a-200c). At S404, the method includes filtering the cell on the basis of band and the geography.

At S406aa, the method includes obtaining the PRB utilization value form a performance management (PM) stored in the memory (130). At S406ab, the method includes computing the PRB weightage for each cell using equation (i.e., AVG DL PRB Utilization Weekly/Max. (AVG DL PRB Utilization Weekly of L4 geography). At S406ac, the method includes computing the DL PRB factor Weightage multiplied with the multiplier factor.

At S406ba, the method includes obtaining the RRC connected user value from the performance management stored in the memory (130). At S406bb, the method includes computing the RRC weightage for each cell using equation (i.e., AVG RRC Connected User_Weekly/Max (AVG RRC Connected User_Weekly of L4 geography). At S406bc, the method includes computing the RRC factor weightage multiplied with the multiplier factor.

At S406ca, the method includes obtaining the morphology weightage. At S406cb, the method includes obtaining the booming cell's morphology factor using the morphology weightage multiplied with the multiplier factor.

At S406da, the method includes computing the total booming distance based on the boomer cell end distance and the boomer cell start distance. At S406db, the method includes computing the distance factor (i.e., Total Distance/Max total distance of L4 Geography) multiplied with the multiplier factor). At S406dc, the method includes computing the distance weightage multiplied with the multiplier factor.

At S406ea, the method includes obtaining the drive test samples which is the part of booming distance. At S406eb, the method includes computing the user density weightage (i.e., booming cell samples/Max Booming Cell samples of L4 geography). At S406ec, the method includes computing the user density weightage multiplied with the multiplier factor.

At S408, the method includes computing the total priority factor by adding all the factors with respect to the cell. At S410, the method includes sorting total factors of all cells in the descending order. It could be ascending order also. At S412, the method includes creating the readable format (e.g., Computable Document Format (CDF) format or the like) from the aggregated data. At S414, the method includes providing the ranking details and prioritizing the cell based on the ranking details.

The proposed method can be used to prioritize the booming cells (e.g., network coverage loopholes or network gaps) so that a user (e.g., radio frequency (RF) engineer or operator) of the electronic device (100) gets to know the exact severity of the booming cells (200a-200c) to optimize the booming cells (200a-200c) for providing better service to the customer. The method can be used to assist the user to decide which booming cells (200a-200c) should be mitigate first based on the identified priority in order to improve the network performance in an important geographical area.

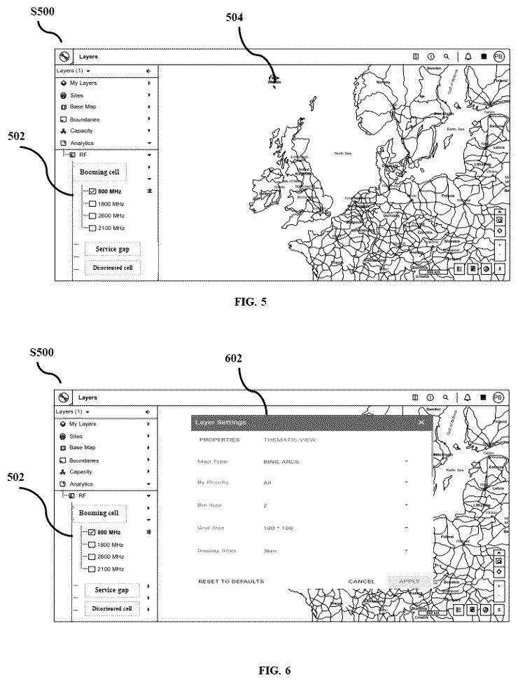

FIG. 5 is an example illustration in which a user interface (S500) of the electronic device (100) displays bandwidth related information and a geography related information (504) to prioritize the booming cells (200a-200c) in the wireless network (1000), according to the embodiments as disclosed herein. The analytics related data (e.g., sites, base map, the booming cell, the service gap or the like) is provided in a left side of the user interface (502).

FIG. 6 is an example illustrations in which the user interface (S500) of the electronic device (100) displays bandwidth related information and layer setting (602) to prioritize the booming cells (200a-200c) in the wireless network (1000), according to the embodiments as disclosed herein.

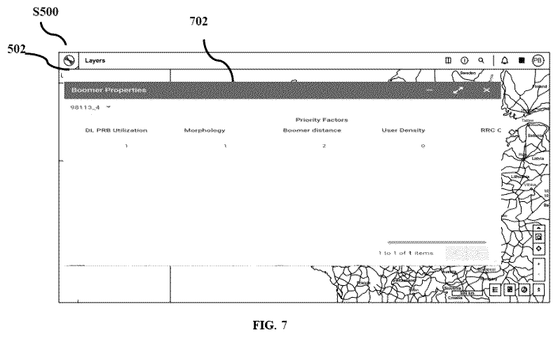

FIG. 7 is an example illustration (S500) in which a user interface (702) of the electronic device (100) prioritizes the booming cells (200a-200c), according to the embodiments as disclosed herein. The user interface (702) displays the boomer properties including the priority factors (e.g., DL PRB utilization, boomer distance, user density, a RRC connected user or the like).

The various actions, acts, blocks, steps, or the like in the flow charts (S300 and S400) may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

We claim:

1. An electronic device for prioritizing booming cells in a wireless network, wherein the electronic device comprises:
a memory; and
a processor, communicatively coupled to a memory, configured to:
receive information about a plurality of booming cells;
determine a morphology factor of each booming cell of the plurality of booming cells;
determine a Physical Resource Block (PRB) utilization factor of each booming cell of the plurality of booming cells;
determine a number of Radio Resource Control (RRC) connected users factor of each booming cell of the plurality of booming cells;
determine a booming distance of each booming cell of the plurality of booming cells;
determine a user density factor of each booming cell of the plurality of booming cells;
determine a priority for each booming cell of the plurality of booming cells based on the morphology factor, the PRB utilization, the RRC connected users, the booming distance, and the user density factor; and
prioritize the plurality of booming cells for mitigation based on the priority for each booming cell of the plurality of booming cells.

2. The electronic device as claimed in claim 1, wherein determine the PRB morphology factor of each booming cell of the plurality of booming cells comprises:
retrieve a weightage for the morphology factor for each booming cell of the plurality of booming cells from a morphology database; and
determine the morphology factor based on the weightage for the morphology factor and a morphology multiplier factor.

3. The electronic device as claimed in claim 1, wherein determine the user density factor of each booming cell of the plurality of booming cells comprises:
retrieve a plurality of samples of the booming cells;
determine a maximum sample of the plurality of samples of the booming cells;
determine a user density weightage based on the plurality of samples of the booming cells and the maximum sample; and
determine the user density factor based on the user density weightage and a user density multiplier factor.

4. The electronic device as claimed in claim 1, wherein determine the booming distance of each booming cell of the plurality of booming cells comprises:
detect the booming cell start distance and the booming cell stop distance of each booming cell of the plurality of booming cells;
determine a total booming distance based on the booming cell start distance and the booming cell stop distance;
determine a booming distance weightage based on the total booming distance and a maximum booming distance; and
determine the booming distance factor based on the booming distance weightage and a booming multiplier factor.

5. The electronic device as claimed in claim 1, wherein determine the PRB utilization factor of each booming cell of the plurality of booming cells comprises:
determine an average PRB utilization on weekly basis;
determine a maximum average PRB utilization on weekly basis;
determine a PRB utilization weightage of each booming cell of booming cells based on the average PRB utilization on the weekly basis and the maximum average PRB utilization on the weekly basis; and
determine the PRB utilization factor based on the PRB utilization weightage and a PRB utilization multiplier factor.

6. The electronic device as claimed in claim 1, wherein determine the number of RRC connected users factor of each booming cell of the plurality of booming cells comprises:
determine an average RRC connected users on weekly basis;
determine a maximum RRC connected users on weekly basis;
determine a number of RRC connected users weightage of each booming cell of booming cells based on the average RRC connected users on the weekly basis and the maximum RRC connected users on the weekly basis; and
determine the number of RRC connected users factor based on the number of RRC connected users weightage and a RRC connected user multiplier factor.

7. The electronic device as claimed in claim 1, wherein prioritize the plurality of booming cells based on the priority for each booming cell of the plurality of booming cells comprises:
sort the priority of the plurality of booming cells in descending order; and
rank the plurality of booming cells based on the sorted priority of the plurality of booming cells.

8. A method for prioritizing booming cells in a wireless network, wherein the method comprises:
receiving, by an electronic device in the wireless network, information about a plurality of booming cells;
determining, by the electronic device, a morphology factor of each booming cell of the plurality of booming cells;
determining, by the electronic device, a Physical Resource Block (PRB) utilization factor of each booming cell of the plurality of booming cells;
determining, by the electronic device, a number of Radio Resource Control (RRC) connected users factor of each booming cell of the plurality of booming cells;
determining, by the electronic device, a booming distance of each booming cell of the plurality of booming cells;
determining, by the electronic device, a user density factor of each booming cell of the plurality of booming cells;
determining, by the electronic device, a priority for each booming cell of the plurality of booming cells based on the morphology factor, the PRB utilization factor, the RRC connected users factor, the booming distance, and the user density factor; and
prioritizing, by the electronic device, the plurality of booming cells for mitigation based on the priority for each booming cell of the plurality of booming cells.

9. The method as claimed in claim 8, wherein determining, by the electronic device, the PRB morphology factor of each booming cell of the plurality of booming cells comprises:
retrieving, by the electronic device, a weightage for the morphology factor for each booming cell of the plurality of booming cells from a morphology database; and
determining, by the electronic device, the morphology factor based on the weightage for the morphology factor and a morphology multiplier factor.

10. The method as claimed in claim 8, wherein determining, by the electronic device, the user density factor of each booming cell of the plurality of booming cells comprises:
retrieving, by the electronic device, a plurality of samples of the booming cells;
determining, by the electronic device, a maximum sample of the plurality of samples of the booming cells;
determining, by the electronic device, a user density weightage based on the plurality of samples of the booming cells and the maximum sample; and
determining, by the electronic device, the user density factor based on the user density weightage and a user density multiplier factor.

11. The method as claimed in claim 8, wherein determining, by the electronic device, the booming distance of each booming cell of the plurality of booming cells comprises:
detecting, by the electronic device, a booming cell start distance and a booming cell stop distance of each booming cell of the plurality of booming cells;
determining, by the electronic device, a total booming distance based on the booming cell start distance and the booming cell stop distance;
determining, by the electronic device, a booming distance weightage based on the total booming distance and a maximum booming distance; and
determining, by the electronic device, the booming distance factor based on the booming distance weightage and a booming multiplier factor.

12. The method as claimed in claim 8, wherein determining, by the electronic device, the PRB utilization factor of each booming cell of the plurality of booming cells comprises:
determining, by the electronic device, an average PRB utilization on weekly basis;
determining, by the electronic device, a maximum average PRB utilization on weekly basis;
determining, by the electronic device, a PRB utilization weightage of each booming cell of booming cells based on the average PRB utilization on the weekly basis and the maximum average PRB utilization on the weekly basis; and
determining, by the electronic device, the PRB utilization factor based on the PRB utilization weightage and a PRB utilization multiplier factor.

13. The method as claimed in claim 8, wherein determining, by the electronic device, the number of RRC connected users factor of each booming cell of the plurality of booming cells comprises:
determining, by the electronic device, an average RRC connected users on weekly basis;
determining, by the electronic device, a maximum RRC connected users on weekly basis;
determining, by the electronic device, a number of RRC connected users weightage of each booming cell of booming cells based on the average RRC connected users on the weekly basis and the maximum RRC connected users on the weekly basis; and
determining, by the electronic device, the number of RRC connected users factor based on the number of RRC connected users weightage and a RRC connected user multiplier factor.

14. The method as claimed in claim 8, wherein prioritizing, by the electronic device, the plurality of booming cells based on the priority for each booming cell of the plurality of booming cells comprises:
sorting, by the electronic device, the priority of the plurality of booming cells in descending order; and
ranking, by the electronic device, the plurality of booming cells based on the sorted priority of the plurality of booming cells.
